(19) United States
(12) Patent Application Publication
(10) Pub. No.: US 2007/0273531 A1
(43) Pub. Date: Nov. 29, 2007

(54) Communication antenna and pole with built-in antenna

(76) Inventors: Koji Ando, Kyoto (JP); Takehiro Kawai, Kyoto (JP)

Correspondence Address: DICKSTEIN SHAPIRO LLP, 1825 EYE STREET NW, Washington, DC, 20006-5403, US

(21) Appl. No.: 11/798,461

(22) Filed: May 14, 2007

(30) Foreign Application Priority Data
May 23, 2006 (JP) P. 2006-143203

(51) Int. Cl. G08B 13/14; H04Q 5/22

(52) U.S. Cl. 340/572.7; 340/10.1

(57) ABSTRACT

An antenna array part constituting a communication antenna is composed of a plurality of antenna elements. The antenna elements are arranged on an arc. This allows radio waves to be irradiated also in the exact transverse direction of the antenna array part, thereby making available the communications with an RFID tag positioned in the exact transverse direction. By shifting the phase of a radio frequency signal supplied to each antenna element or adjusting the amplitude of the radio frequency signal, it is possible to change the direction of radio beams irradiated from the antenna array part or expand the width of the radio beams thus making available with RFID tags present in a wider area.

This application claims priority to Japanese Patent Application No. 2006-143203, filed May 23, 2006, in the Japanese Patent Office. The priority application is incorporated by reference in its entirety.

1. Technical Field

The present disclosure relates to a communication antenna used in a tag communication device such as an RFID reader-writer and a pole that incorporates the communication antenna.

2. Related Art

A communication antenna used in an RFID reader-writer is used while mounted on a wall and generally a planar antenna is desirable. For example, in case communication antennas are mounted on both sides of a conveyer in a factory, an article on the conveyer could collide with the communication antennas. In case a communication antenna is mounted on a dock door in a delivery station, a truck or other vehicles could collide with the communication antenna.

A patch antenna is often used as this type of planar antenna. The width of beams of radio waves irradiated from a patch antenna is approximately 60 degrees. Thus, radio waves are unlikely to be propagated across an area wider than 60 degrees. It is difficult to communicate with RFID tags present in a wide area.

In the related art, multiple communication antennas are installed or a single communication antenna is moved to allow communications with RFID tags present in a wide area. (For a technique to install multiple communication antennas, refer to Patent Reference 1 (Japanese Patent Unexamined Publication No. 2003-072919), for example. For a technique to move a communication antenna, refer to Patent References 2 (Japanese Patent Unexamined Publication No. 2005-157919) and 3 (Japanese Patent Unexamined Publication No. 2004-280414), for example.)

According to a related art system where multiple communication antennas are installed, an increase in the number of communication antennas invites higher costs and there is a need to provide spaces to install multiple antennas. In a place where such spaces are not sufficiently available, the number of antennas is insufficient and RFID tags are inevitably incapable of communicating with antennas, and a wide area is not supported.

According to a related art system where a single communication antenna is moved, there is a need for means to move a communication antenna. This leads to higher costs and it is necessary to provide a travel path for the communication antenna. In a place where such a travel path is unavailable and a communication antenna cannot be move physically, a large number of RFID tags fail to communicate with the antenna, and a wide area is not supported.

### SUMMARY

Embodiments of the present invention provide a communication antenna that is communicable with RFID tags present in a wide area with a small number of antennas and a pole with a built-in antenna.

One or more embodiments of the present invention provides a communication antenna used in a communication device for performing wireless communications with an RFID tag over radio waves, the communication antenna comprising: an antenna array part where a plurality of antenna elements are arranged on an arc; and a variable unit for making variable the phase and/or amplitude of a radio frequency signal supplied to each of the antenna elements.

For example, the communication antenna according to one or more embodiments of the present invention may be configured so that the direction of radio beams irradiated from the antenna array part is changed by shifting the phase of a radio frequency signal supplied to each of the antenna elements via the variable unit.

In case a configuration is employed where the direction of beams is changed, for example, the communication antenna according to one or more embodiments of the present invention may be configured to comprise a plurality of moving body detection sensors arranged in the direction the radio wave beams change, wherein the moving body detection sensor detects a moving body ahead of the antenna array part and the direction of the radio beams changes based on the result of detection.

The communication antenna according to one or more embodiments of the present invention may be configured to expand the width of radio beams irradiated from the antenna array part by adjusting the amplitude of a radio frequency signal supplied to each of the antenna elements via the variable unit.

The antenna array part may be configured by a patch antenna composed of a plurality of antenna elements. In general, a patch antenna is a planar antenna where one surface is a metallic plate placed on a dielectric board and the other surface is a ground plate (metallic plate).

Further, a pole with a built-in antenna according to one or more embodiments of the present invention is a pole incorporating the communication antenna.

The pole with a built-in antenna according to one or more embodiments of the present invention may be wherein, for example, the plurality of antenna elements of the communication antenna are arranged on an arc along the direction of the circumference of the pole.

The wording “the plurality of antenna elements of the communication antenna are arranged on an arc” includes a condition where, in case the external shape of a member where a plurality of antenna elements are arranged is a curved surface, the antenna elements are arranged along the arc of the curved surface.

The “pole” includes one with a variety of cross sections such as a circle, an ellipse, and a polygon. The wording “the plurality of antenna elements of the communication antenna are arranged on an arc along the direction of the circumference of the pole” includes a condition where, with a pole having a circular cross section, a plurality of antenna elements are arranged along the arc of the circle, and with a pole having an elliptical cross section, a plurality of antenna elements are arranged along the arc of the ellipse, and with a pole having a polygonal cross section, a plurality of antenna elements are arranged along the arc of a circle that is inscribed in the polygon.

The “RFID tag” includes a passive-type RFID tag that does not have a power source such as a battery and whose circuit operates on the power transmitted over radio waves from a tag communication device such as an RFID reader-writer and performs wireless communications with the tag communication device, and an active-type RFID tag equipped with a power source such as a battery.

The “tag communication device” may be any device capable of communicating with an RFID tag via radio waves and may be an RFID reader-writer, an RFID reader, or an RFID writer.

One or more embodiments of the present invention may include one or more the following advantages.

For example, the antenna array part of the one or more embodiments of the present invention employs a configuration where a plurality of antenna elements are arranged on an arc. Thus, radio waves are also irradiated in the exact transverse direction of the antenna array part. This enables communications with an RFID tag positioned in the exact transverse direction. A communication antenna to communicate with the RFID tag can be omitted and thus a small number of antennas provide communications with RFID tags present in a wide area.

Further, the one or more embodiments of the present invention comprises the variable unit that makes variable the phase and/or amplitude of a radio frequency signal supplied to each of the antenna elements. It is thus possible to change the direction of radio beams irradiated from the antenna array part by shifting the phase of a radio frequency signal supplied to each antenna element via the variable unit, or making available communications with RFID tags present in a wider area by expanding the width of radio beams irradiated from the antenna array part by adjusting the amplitude of the radio frequency signal.

Other features and advantages may be apparent from the following detailed description, the accompanying drawings and the claims.

### BRIEF DESCRIPTION OF THE DRAWINGS

FIG. 1 is a block diagram of a communication antenna to which the invention is applied.

FIG. 2 illustrates an example where an antenna array part is composed of three antenna elements.

FIG. 3(1) shows a shape pattern of radio beams irradiated from an antenna array part composed of three antenna elements.

FIG. 3(2) shows another shape pattern of radio beams irradiated from an antenna array part composed of three antenna elements.

FIG. 3(3) shows another shape pattern of radio beams irradiated from an antenna array part composed of three antenna elements.

FIG. 3(4) shows another shape pattern of radio beams irradiated from an antenna array part composed of three antenna elements.

FIG. 3(5) shows another shape pattern of radio beams irradiated from an antenna array part composed of three antenna elements.

FIG. 4(A) illustrates a beam pattern assumed in case all antenna elements transmits radio waves in the same phase.

FIG. 4(B) illustrates a beam pattern assumed in case all antenna elements transmits radio waves in the same phase.

FIG. 5 illustrates the relationship between the propagating direction of radio waves irradiated from the antenna array part and the phase shift.

FIG. 6 illustrates an operation principle of changing the direction of radio beams by using a variable phase shifter.

FIG. 7(A) illustrates a wide beam pattern.

FIG. 7(B) illustrates a wide beam pattern.

FIG. 8(A) illustrates a specific configuration example of an antenna array part and is a plan view of antenna array part.

FIG. 8(B) illustrates a specific configuration example of an antenna array part and is a front view thereof.

FIG. 8(C) illustrates the radio beams irradiated from the antenna array part in FIG. 8 (A).

FIG. 8(D) illustrates an exemplary antenna array part capable of irradiating radio waves in the exact transverse direction.

FIG. 9 shows a cross section of a pole with a built-in antenna.

FIG. 10(A) illustrates an exemplary structure where a moving body detection sensor is added to a pole with a built-in antenna and is a perspective explanatory view of the pole.

FIG. 10(B) illustrates an exemplary structure where a moving body detection sensor is added to a pole with a built-in antenna and is a block diagram of a communication antenna including a moving body detection sensor.

FIG. 11 is a flowchart of the operation to switch between beam patterns based on a detection signal from a moving body detection sensor in the control circuit.

FIG. 12(A) illustrates a beam pattern switched over by the operation of FIG. 11.

FIG. 12(B) illustrates a beam pattern switched over by the operation of FIG. 11.

FIG. 12(C) illustrates a beam pattern switched over by the operation of FIG. 11.

FIG. 13 illustrates the operation to communicate with an RFID tag with a beam pattern switched over.

FIG. 14(A) illustrates an exemplary pole structure assuming a case where the incoming direction of a moving body is unknown and shows a plane cross section of the pole.

FIG. 14(B) illustrates an exemplary pole structure assuming a case where the incoming direction of a moving body is unknown and shows a side cross section of the pole.

FIG. 15(A) illustrates an exemplary pole structure assuming a case where the incoming direction of a moving body is previously known as a specific direction and shows a plane cross section of the pole.

FIG. 15(B) illustrates an exemplary pole structure assuming a case where the incoming direction of a moving body is previously known as a specific direction and shows a side cross section of the pole.

FIG. 16(A) illustrates an exemplary pole structure assuming a case where a moving body passes in front of and behind the pole and shows a plane cross section of the pole.

FIG. 16(B) illustrates an exemplary pole structure assuming a case where a moving body passes in front of and behind the pole and shows a side cross section of the pole.

FIG. 17(A) illustrates an exemplary pole structure assuming a case where a moving body detection sensor with a wide sensing range is used and shows a plane cross section of the pole.

FIG. 17(B) illustrates an exemplary pole structure assuming a case where a moving body detection sensor with a wide sensing range is used and shows a side cross section of the pole.

FIG. 18(A) illustrates an exemplary pole structure assuming a case where a moving body detection sensor with a wide sensing range is used and shows a plane cross section of the pole.

FIG. 18(B) illustrates an exemplary pole structure assuming a case where a moving body detection sensor with a wide sensing range is used and shows a side cross section of the pole.

### DETAILED DESCRIPTION

The best embodiments of the invention will be described referring to attached drawings.

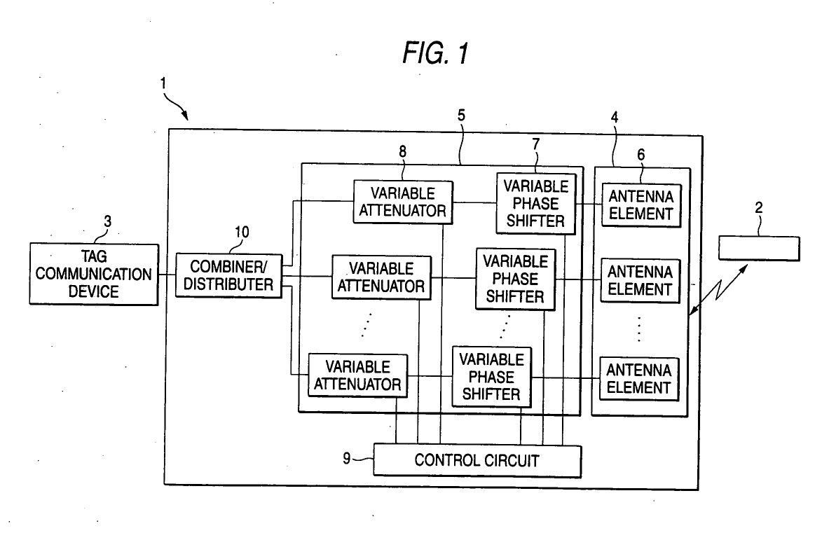

FIG. 1 is a block diagram of a communication antenna to which the invention is applied. A communication antenna 1 is an antenna used in a tag communication device 3 such as an RFID reader-writer performing wireless communications with an RFID tag 2 over radio waves and includes an antenna array part 4 and a variable unit 5. The antenna array part 4 includes a plurality of antenna elements 6. The arrangement of the antenna elements 6 will be described later.

To each antenna element 6 are connected one variable phase shifter 7 and one variable attenuator 8 of the variable unit 5. The variable phase shifter 7 and the variable attenuator 8 are connected to a control circuit 9. The control circuit 9 outputs a control signal to the variable phase shifter 7 to shift the phase of a radio frequency signal supplied from the tag communication device 3 to the antenna element 6 via a combiner/distributer 10. The control circuit 9 outputs a control signal to the variable attenuator 8 to change the amplitude of a radio frequency signal supplied to the antenna element 6 as mentioned above.

The communication antenna 1 is capable of changing radio beams irradiated from the antenna array part 4 into am arbitrary pattern by changing the phase and amplitude or only the amplitude of a radio frequency signal supplied to each antenna element 6 by way of the variable unit 5.

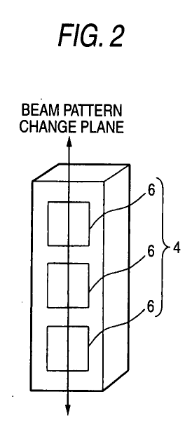

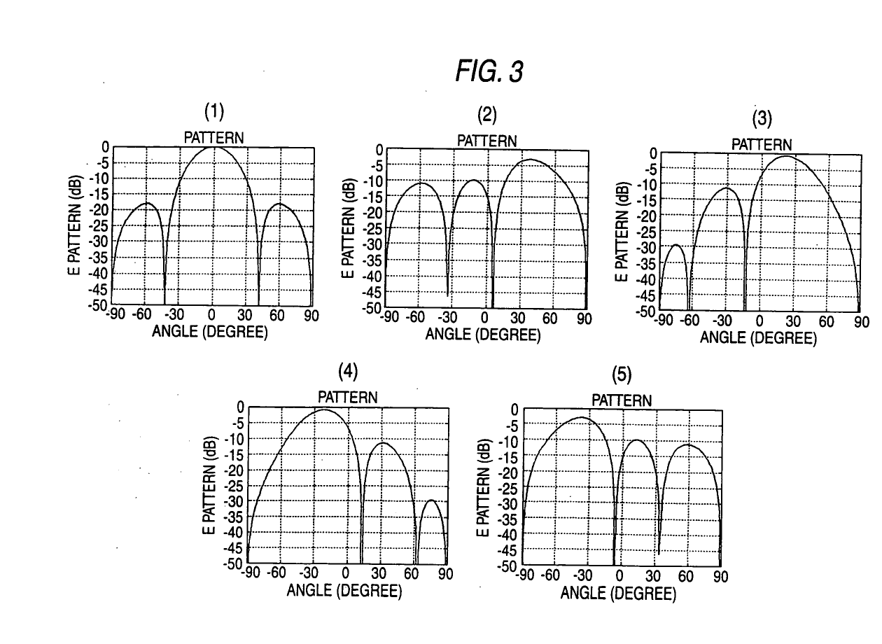

For example, as shown in FIG. 2, in case three antenna elements 6 are used, by shifting the phase of a radio frequency signal supplied to each antenna element 6, the beam pattern of radio waves irradiated from the antenna array part 4 is changed as shown in FIGS. 3(1) to (5) and the radio beam direction is changed.

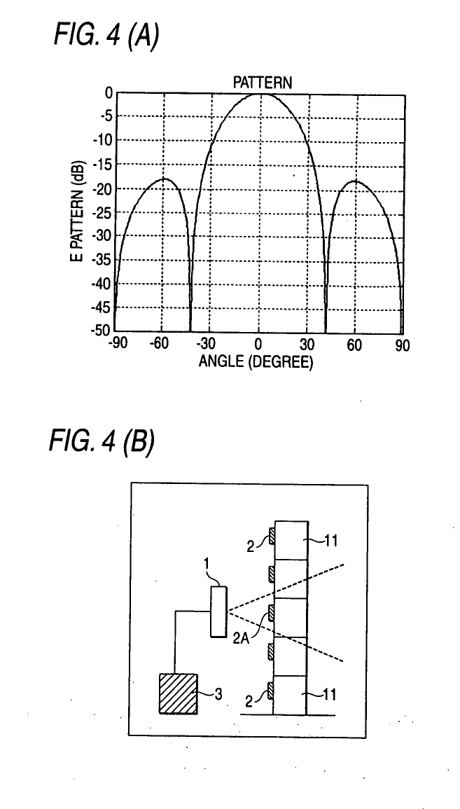

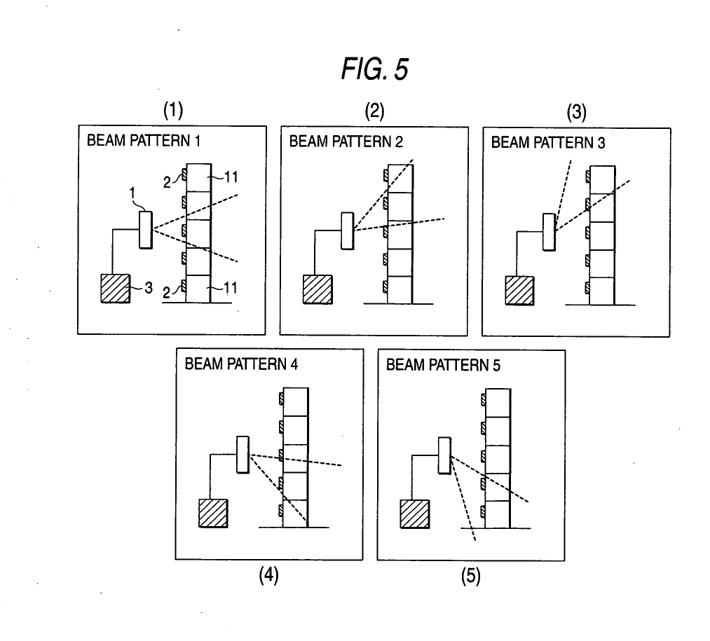

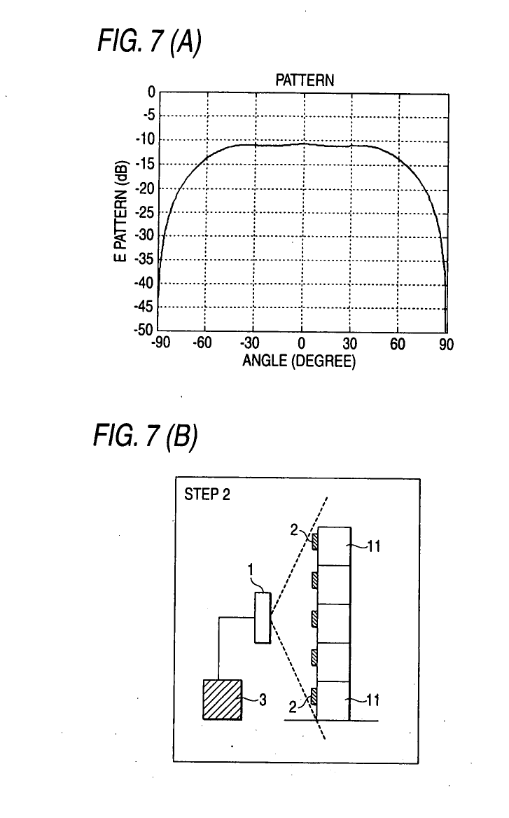

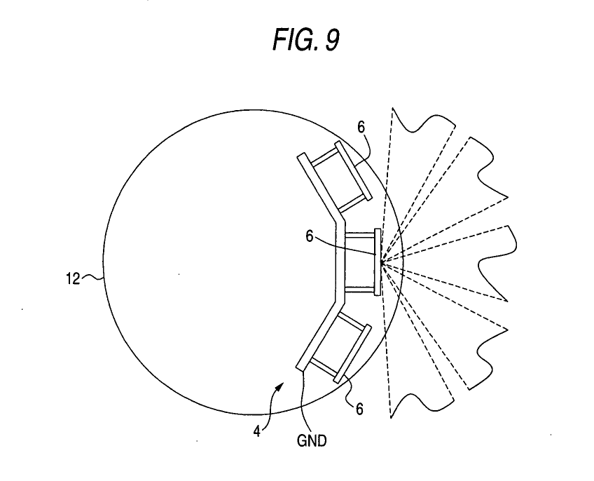

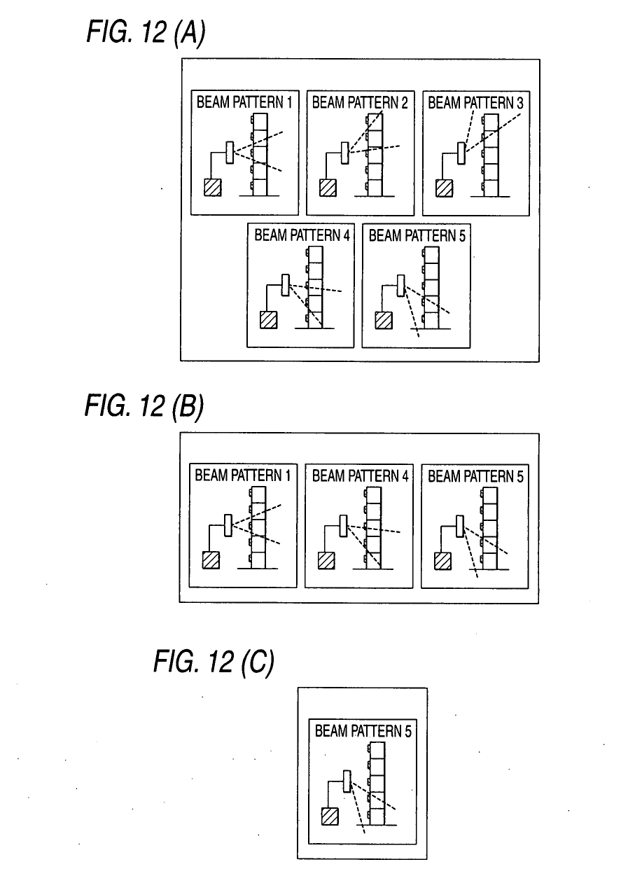

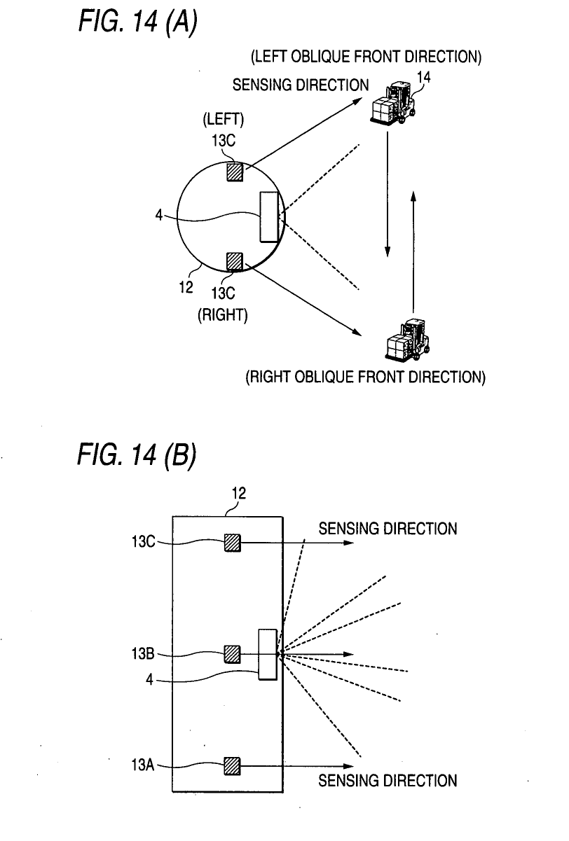

FIG. 3(1) and FIG. 4(A) show a beam pattern assumed in case all antenna elements 6 transmit radio waves in the same phase. In this example, radio waves irradiated from the antenna array part 4 propagate as planar waves in a direction perpendicular to the arrangement of the antenna elements 6 as shown in FIG. 4(B) and FIG. 5(1). In order to change the direction of radio beams irradiated in such a direction as shown in FIGS. 5(2) to (5), the phase of radio waves transmitted by each antenna element 6 should be shifted to each other so as to satisfy the expression given below. Dotted lines in FIG. 4(B) and FIGS. 5(1) to (5) show areas where communications with the RFID tag 2 are available. This is the same for FIG. 7(B), FIG. 9, FIG. 12, and FIGS. 14 to 18.

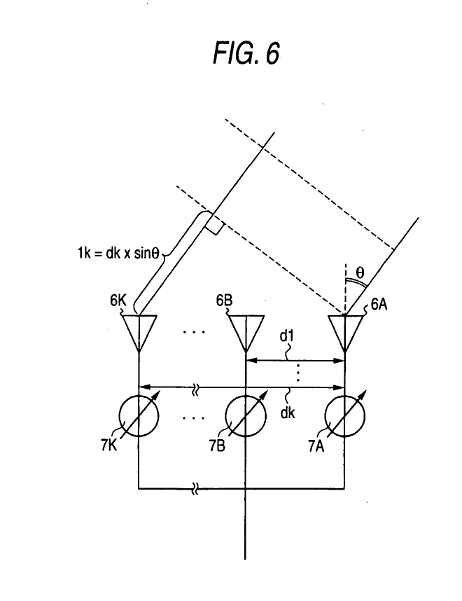

As shown in FIG. 6, given the wavelength of radio waves as λ(m), the distance between a reference antenna element 6A and the kth antenna element 6K as dk (m), and the distance between an equiphase wave surface passing through the antenna element 6A as a reference among the equiphase wave surfaces shown by broken lines in FIG. 2 and the kth antenna element 6K as 1 k(m), the phase shift φk of the kth antenna element 6K with respect to the phase of the antenna element 6A as a reference is given by the following expression.

φk=(1k/λ)×2π(dk×sin θ/λ)×2π [Expression 1]

With only one beam pattern shown in FIG. 4, communications are available with a single RFID tag 2 within the range of the beam pattern. According to the communication antenna 1, the radio beam pattern changes as shown in FIGS. 5(1) to (5) with the direction of the radio beam changed. Thus, an area where communications with the RFID tag 2 are available is expanded and communications with RFID tags 2 scattered in a wide range are made available with a single antenna. In the example of FIG. 5, objects to be managed each having an RFID tag 2 attached thereon (hereinafter referred to as the management object 11) are laminated in multiple layers, so that a plurality of RFID tags 2 are scattered in a wide vertical range. In this case also, all RFID tags 2 are within the range of any beam pattern as shown in FIG. 5 so that no RFID tags 2 fail to communicate and communications with all RFID tags 2 are available.

In the case where three antenna elements 6 are used as shown in FIG. 2, the beam pattern of radio waves irradiated from the antenna array part 4 is changed for example from one shown in FIG. 4 to one shown in FIG. 7 as the amplitude of a radio frequency signal supplied to each antenna element 6, and the beam width of the radio waves is expanded.

With a narrow beam pattern shown in FIG. 4, communications with only one RFID tag 2A are available. The communication antenna 1 uses a wide beam pattern shown in FIG. 7. This expands the area where communications with the RFID tag 2 are available. This means that a single communication antenna 1 is capable of communicating with RFID tags 2 scattered in a wide range. In the example of FIG. 7, same as FIG. 5, a plurality of RFID tags are scattered in a wide vertical range. In this case also, all RFID tags 2 are within the range of any beam pattern as shown in FIG. 7 so that no RFID tags 2 fail to communicate and communications with all RFID tags 2 are available.

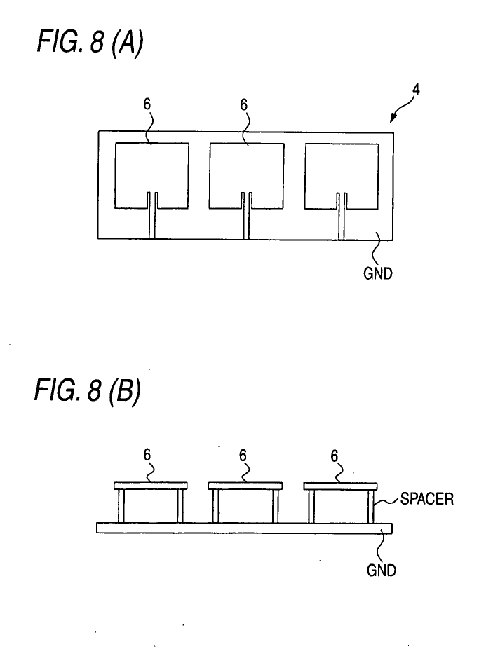

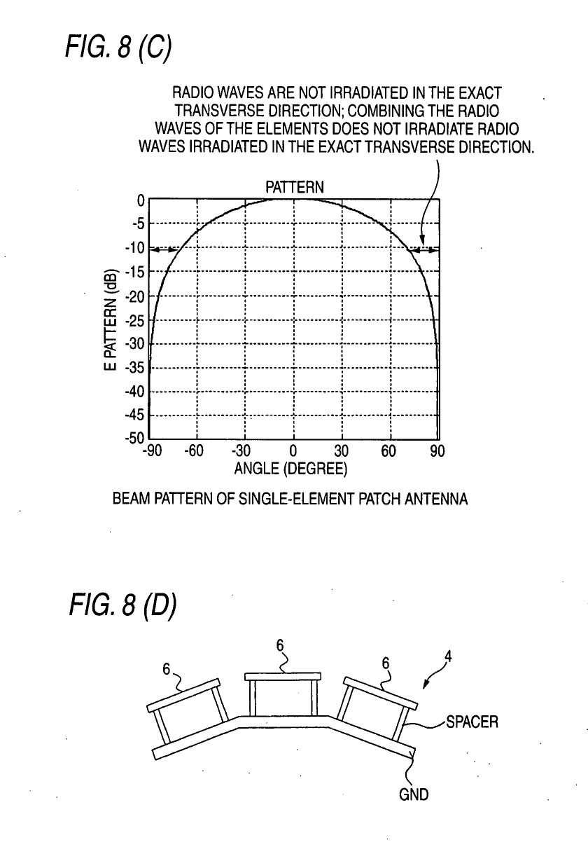

FIG. 8 illustrates a specific configuration example of an antenna array part 4. The antenna array part 4 may be a patch antenna shown in FIG. 8(A). In this case also, it is possible to expand the radio beams irradiated from the patch antenna by changing the amplitude of a radio frequency signal supplied to a plurality of antenna elements 6 constituting the patch antenna although the degree of expansion is limited. To be more precise, the width of the radio beams irradiated from the patch antenna is about 60 degrees so that the radio waves are not irradiated in the exact transverse direction. Thus, even when the amplitude of the radio frequency signal is changed, the radio waves are not irradiated in the exact transverse direction of the patch antenna (the exact transverse direction is +90 degrees and −90 degrees assuming the front of the antenna array part 4 is in the direction of 0 degrees) as understood from FIG. 8(C). As a result, communications with an RFID tag positioned in the exact transverse direction are unavailable.

This problem can be solved by the use of the antenna array part 4 shown in FIG. 8(C). The antenna array part 4 of FIG. 8(C) which is a patch antenna has a plurality of antenna elements 6 as components thereof arranged on an arc. Such an arc-shaped arrangement of the antenna elements 6 allows radio waves to be irradiated in the almost transverse direction of the antenna array part 4, thus expanding the range where communications with an RFID tag are available. The above arrangement of the antenna elements 6 is applicable to an antenna other than the patch antenna.

The communication antenna 1 according to this embodiment may be built into a pole 12 as shown in FIG. 9. In the example of FIG. 9, a plurality of antenna elements 6 constituting the antenna array part 4 of the communication antenna 1 are arranged side by side on an arc along the direction of circumference of the pole 12. In the example of FIG. 9, the pole 12 has a circular cross section so that the plurality of antenna elements 6 are arranged along the arc of the circle. For example, in case the plurality of antenna elements are to be built into a pole having an elliptical cross section, the plurality of antenna elements may be arranged along the arc of the ellipse. With these configurations, the range where communications with an RFID tag are available is expanded as mentioned earlier and also a communication antenna can be protected.

An antenna element for the 900 MHz band may be provided by a dielectric board 10 cm by 10 cm in vertical and horizontal size. In case a patch antenna composed of three antenna elements 6 shown in FIG. 9 is built into a pole 12, the pole 12 with a radius of 30 cm is sufficient.

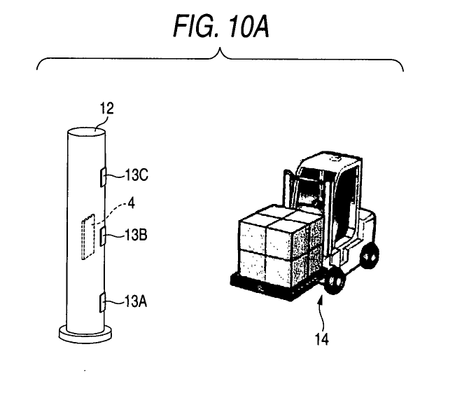

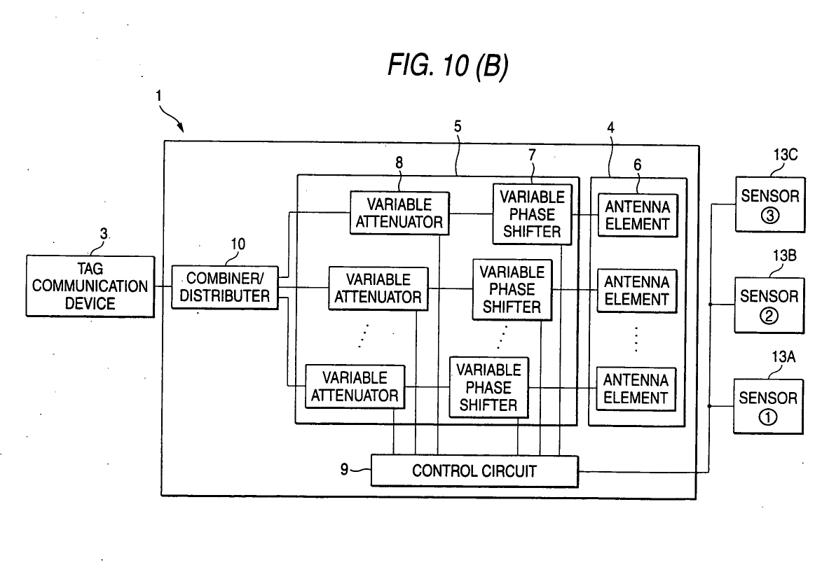

In the above embodiment, the beam pattern of the radio waves irradiated from the antenna array part 4 is arbitrarily changed as shown in FIGS. 5(1) to (5) so that the direction of the radio beams will be arbitrarily changed. For example, as shown in FIG. 10, a plurality of moving body detection sensors 13A, 13B, 13C may be arranged on the pole 12 in order to identify the range of an object of detection based on a detection signal from the plurality of moving body detection sensors 13A, 13B, 13C, and the beam patterns of the radio waves may be switched for the identified range. In the example of FIG. 10, the plurality of moving body detection sensors 13A, 13B, 13C are arranged in the direction the radio beams change (direction of height of the pole 12) and detect as a detection object a moving body 14 such as a forklift passing in the neighborhood of the pole 12, and outputs the detection signal to the control circuit 9. The control circuit 9 performs processing such as identification of the range of a detection object based on a detection signal coming from each of the moving body detection sensors 13A, 13B, 13C and switching between beam patterns of the radio waves for the identified range as a target. In FIG. 10, a same member as that in FIG. 1 is given a same sign and the detailed description of the same member is omitted.

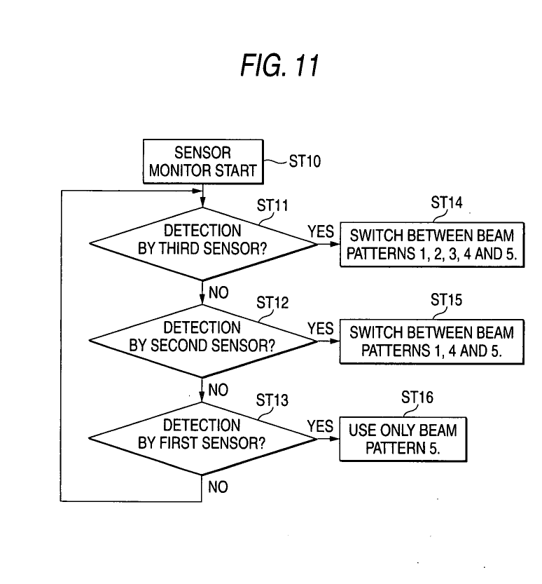

FIG. 11 is a flowchart of the operation to switch between beam patterns based on a detection signal from the moving body detection sensors 13A, 13B, 13C in the control circuit 9.

According to the flowchart of FIG. 11, the operation is started by a push on a monitor start button (not shown). All the moving body detection sensors are place in the monitor state to monitor a moving body in front of the antenna array part (ST10). In the control circuit 9, it is determined whether a third moving body detection sensor 13C, a second moving body detection sensor 13B, or a first moving body detection sensor 13A has detected a moving body in this order (ST11, ST12, ST13).

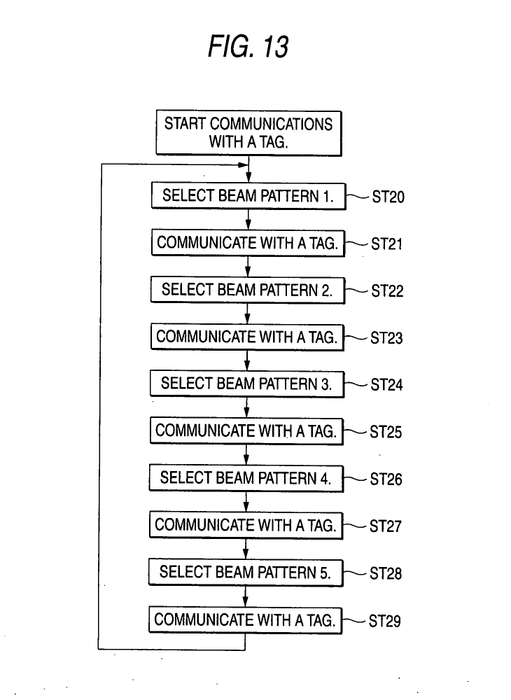

In the control circuit 9, it is determined whether a detection signal is inputted starting with the third moving body detection sensor 13C (ST11). In case a detection signal is inputted, there is a possibility of at least an RFID tag 2 being present in a position lower than the neighborhood of the installation position of the third moving body detection sensor 13C and selection is made between the beam patterns 1, 2, 3, 4 and 5 in FIG. 5 as shown in FIG. 12(A) in order to make available the communications with the RFID tag 2 in that position. As shown in ST20 to ST29 in FIG. 13, one of the beam patterns 1, 2, 3, 4 and 5 in FIG. 5 is sequentially selected and communications with the RFID tag 2 are made each time a new beam pattern is selected (Yes in ST11, ST14).

In case a detection signal is not inputted from the third moving body detection sensor 13C in ST11, it is determined whether a detection signal is inputted from the second moving body detection sensor 13B (ST12). In case a detection signal is inputted, there is a possibility of at least an RFID tag 2 being present in a position lower than the neighborhood of the installation position of the second moving body detection sensor 13B and selection is made between the beam patterns 1, 4 and 5 in FIG. 5 as shown in FIG. 12(B) in order to make available the communications with the RFID tag 2 alone in that position. One of the beam patterns 1, 4 and 5 in FIG. 5 is selected as shown in FIG. 12(B). That is, selection is made sequentially between the beam patterns 1, 4 and 5 in FIG. 5 and communications with the RFID tag 2 are made each time a new beam pattern is selected (Yes in ST12, ST15).

In case a detection signal is not inputted from the second moving body detection sensor 13B in ST12, it is determined whether a detection signal is inputted from the first moving body detection sensor 13A (ST13). In case a detection signal is inputted, there is a possibility of at least an RFID tag 2 being present in a position lower than the neighborhood of the installation position of the third moving body detection sensor 13A and only the beam pattern 5 in FIG. 5 is selected as shown in FIG. 12(C) in order to make available the communications with the RFID tag 2 alone in that position. After communications with the RFID tag, execution returns to the processing of ST11.

Another approach is possible where the above selection of beam patterns and communications are repeated several times and when the repeated processing is over, execution returns to the processing of ST10.

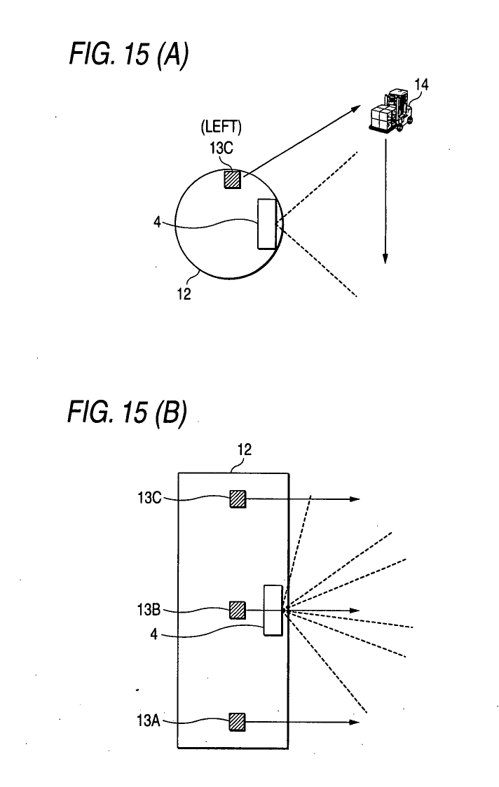

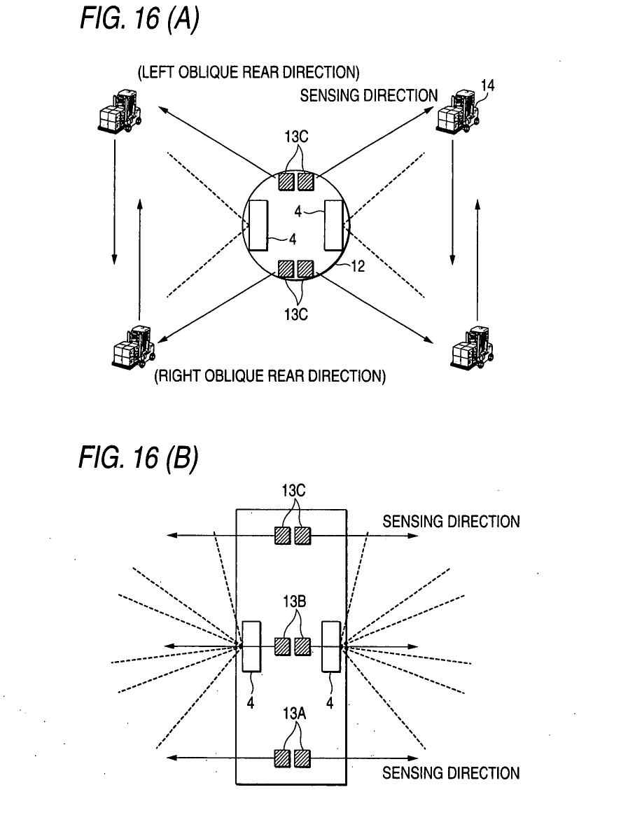

FIGS. 14 to 16 illustrate a pole incorporating a moving body detection sensor and a communication antenna. In particular, FIG. 14 shows an exemplary pole structure assuming a case where the incoming direction of a moving body is unknown. FIG. 15 illustrates an exemplary pole structure assuming a case where the incoming direction of a moving body is previously known as a specific direction. FIG. 16 illustrates an exemplary pole structure assuming a case where a moving body passes in front of and behind the pole.

In the exemplary pole structure shown in FIG. 14, in a front of the pole 12, the direction (right or left) from which a moving body 14 will approach, is unknown. Thus, moving body detection sensors 13A, 13B, 13C are built into each of the right and left sides of the pole 12. The sensing direction of the moving body detection sensors 13A, 13B, 13C built into the left side of the pole 12 is the left oblique front direction as shown in FIG. 14(A). On the other hand, the sensing direction of the moving body detection sensors 13A, 13B, 13C built into the right side of the pole is the right oblique front direction, opposite to that of the moving body detection sensors on the left side, as shown in FIG. 14(A).

In the exemplary pole structure of FIG. 15, it is known that the incoming direction of the moving body 14 is in the left oblique front direction of the pole 12 as shown in FIG. 15(A). Thus, the moving body detection sensors 13A, 13B, 13C are built into only the left side of the pole 12 and the sensing direction of the moving body detection sensors 13A, 13B, 13C is set to the left oblique front direction.

In the exemplary pole structure of FIG. 16, the moving body 14 passes in front of and behind the pole 12. Thus, another pair of right and left moving body detection sensors 13A, 13B, 13C shown in FIG. 14 is further installed. The sensing direction of the moving body detection sensors on the left side 13A, 13B, 13C is set to the left oblique rear direction as shown in FIG. 16(A). The sensing direction of the moving body detection sensors on the right side 13A, 13B, 13C is set to the right oblique rear direction, opposite to that of the moving body detection sensors on the left side 13A, 13B, 13C, as shown in FIG. 16(A). In this exemplary pole structure shown in FIG. 16, a communication antenna is separately provided on the rear side in addition to one on the front side in order to make available the communications with an RFID tag on a moving body 14 passing behind the pole 12.

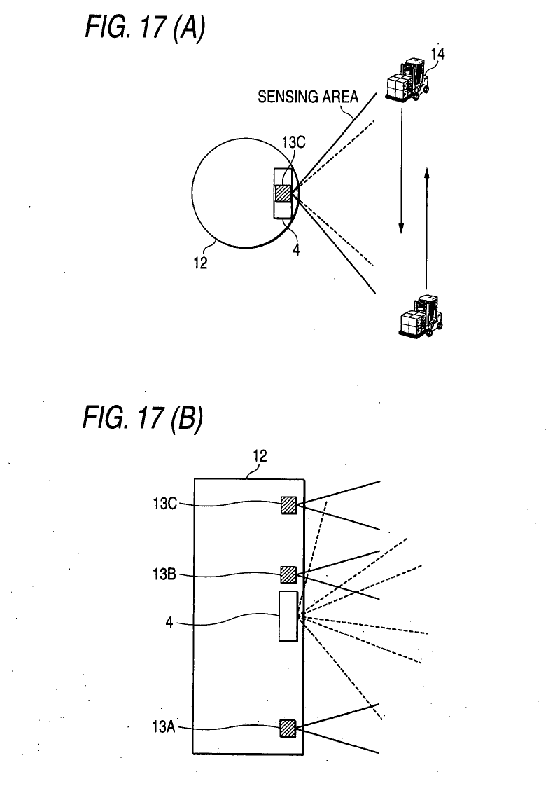

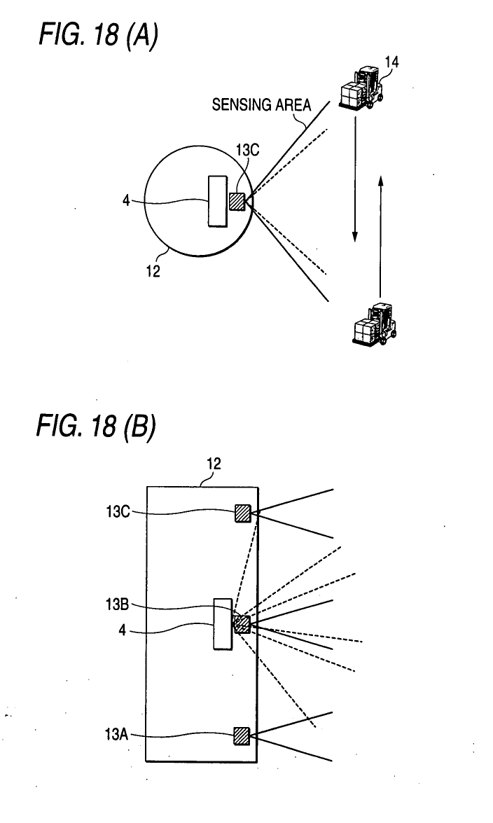

FIGS. 17 and 18 illustrate the structure of a pole incorporating a moving body detection sensor and a communication antenna. In particular, FIGS. 17 and 18 show an exemplary structure of a pole using a moving body detection sensor with a wide sensing range.

The sensing direction of the exemplary structure in FIG. 17 and FIG. 18 of the moving body detection sensors 13A, 13B, 13C is a wide range from the sensing direction line of the moving body detection sensor 13C on the left side shown in FIG. 14 to the sensing direction line of the moving body detection sensor 13C on the right side. Thus, with the exemplary pole structure of FIGS. 17 and 18, by incorporating the moving body detection sensors 13A, 13B, 13C with such a wide sensing range in the front surface of the pole 12, any incoming moving body 14 from either the left or right direction of the front of the pole 12 can be detected with a singe moving body detection sensor, which simplifies the pole structure.

In the exemplary pole structure of FIG. 17, in order to avoid the influence on the radio waves irradiated from the antenna array part 4, a moving body detection sensor 13B is installed outside the area of the radio beams. Provided that the moving body detection sensor 13B is small enough not to have an influence on the radio beams, the moving body detection sensor 13B may be arranged in front of the antenna array part 4 as shown in FIG. 18. Such an arrangement of the antenna array part 4 and the moving body detection sensor 13B is applicable to a moving body 14 passing in front of the pole 12 as well as a moving body 14 passing behind the pole 12 as shown in FIG. 16.

While a control circuit 9 is provided on the side of the communication antenna 1 in FIGS. 1 and 10, the control circuit 9 may be arranged on the side of the tag communication device 3.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A communication antenna used in a communication device for performing wireless communications with an RFID tag over radio waves, said communication antenna comprising:
an antenna array part where a plurality of antenna elements are arranged on an arc; and
a variable unit for making variable at least one of the phase or amplitude of a radio frequency signal supplied to each of said antenna elements.

2. The communication antenna according to claim 1, wherein said variable unit shifts the phase of a radio frequency signal supplied to each of said antenna elements to change the direction of radio beams irradiated from said antenna array part.

3. The communication antenna according to claim 2, further comprising:
a plurality of moving body detection sensors arranged in the direction said radio wave beams change, wherein
said moving body detection sensor detects a moving body ahead of said antenna array part and the direction of said radio beams changes based on the result of detection.

4. The communication antenna according to claim 1, wherein said variable unit adjusts the amplitude of a radio frequency signal supplied to each of said antenna elements to expand the width of radio beams irradiated from said antenna array part.

5. The communication antenna according to claim 1, wherein said antenna array part is configured by a patch antenna composed of a plurality of antenna elements.

6. A pole with a built-in antenna incorporating the communication antenna according to claim 1.

7. The pole with a built-in antenna according to claim 6, wherein
said plurality of antenna elements of said communication antenna are arranged on an arc along the direction of the circumference of said pole.
